(19) United States
(12) Patent Application Publication
(10) Pub. No.: US 2024/0303116 A1
(43) Pub. Date: Sep. 12, 2024

(54) APPARATUS AND METHOD FOR MEMORY RESOURCE EXPANSION

(71) Applicant: ELECTRONICS AND TELECOMMUNICATIONS RESEARCH INSTITUTE, Daejeon (KR)

(72) Inventors: Ji Wook YOUN, Daejeon (KR); Daeub KIM, Daejeon (KR); Bup Joong KIM, Daejeon (KR); Chanho PARK, Daejeon (KR); Jongtae SONG, Daejeon (KR); Joon Ki LEE, Daejeon (KR); Kyeong-Eun HAN, Daejeon (KR)

(73) Assignee: ELECTRONICS AND TELECOMMUNICATIONS RESEARCH INSTITUTE, Daejeon (KR)

(21) Appl. No.: 18/601,084

(22) Filed: Mar. 11, 2024

(30) Foreign Application Priority Data
Mar. 9, 2023 (KR) 10-2023-0030966

(51) Int. Cl. G06F 9/50; G06F 13/42

(52) U.S. Cl. CPC G06F 9/5016; G06F 13/4221; G06F 2209/503; G06F 2213/0026

(57) ABSTRACT

Provided are a processing system and method for increasing memory resources. The method includes generating, by a host node, a device memory resource request and transmitting the device memory resource request to a network manager, providing, by the network manager, memory node information and connection information to the host node in response to the memory resource request, generating, by the host node, an optical link frame corresponding to the request, connecting, by the network manager, a memory node whose memory resources are available and the host node by controlling an optical switch, and communicating, by the host node and the memory node of which memory resources are available, with each other using a light signal corresponding to the optical link frame.

### CROSS-REFERENCE TO RELATED APPLICATION

This application claims priority to and the benefit of Korean Patent Application No. 10-2023-0030966, filed on Mar. 9, 2023, the disclosure of which is incorporated herein by reference in its entirety.

### BACKGROUND

### 1. Field of the Invention

The present disclosure generally relates to a method and processing system for increasing memory resources.

### 2. Discussion of Related Art

With the development of cloud services, traffic inside data centers is drastically increasing, and features of traffic are changing to become more service-centric. In a service-centric environment, extremely asymmetric resource utilization occurs where a service performing some specific functions consumes most of computing or memory resources. As an example, some computing-centric services use 95% or more of the processing capability of a central processing unit (CPU) in a server but only use less than 10% of the total amount of memory. In the case of providing such a service using a current server-centric data center structure, even when sufficient memory resources are available, it is not possible to use the memory resources to accommodate another service, which significantly degrades the utilization of network resources.

### SUMMARY OF THE INVENTION

To solve the foregoing problem of the related art, resource-centric data center structures are being researched where network resources are classified by characteristic, implemented by hardware, and connected by an interconnect interface. However, current resource-centric data center structures are based on a peripheral component interconnect express (PCIe) interface, which significantly limits an increase in the distance between network resources and an increase in shared memory capacity.

The present disclosure is directed to providing a method of increasing shared memory capacity by expanding memory resources, which are directly controllable by a central processing unit (CPU) in a resource-centric data center structure based on a PCIe interface, to a network domain.

According to an aspect of the present disclosure, there is provided a method of increasing memory resources, the method including generating, by a host node, a device memory resource request and transmitting the device memory resource request to a network manager, providing, by the network manager, memory node information and connection information to the host node in response to the memory resource request, generating, by the host node, an optical link frame corresponding to the request, connecting, by the network manager, a memory node whose memory resources are available and the host node by controlling an optical switch, and communicating, by the host node and the memory node of which memory resources are available, with each other using a light signal corresponding to the optical link frame.

According to another aspect of the present disclosure, there is provided a processing system for increasing memory resources, the processing system including a host node which includes a processing unit including a processor configured to generate a device memory resource request and a matching unit including a frame matcher configured to generate an optical link frame from the memory resource request, a memory node which includes a memory unit including a device memory and a memory controller configured to control the device memory, an optical switch configured to optically connect the host node and the memory node, and a network manager configured to control the optical switch so that the host node is connected to the memory node and increases memory resources.

The matching unit may further include a physical layer configured to convert the optical link frame which is an electrical signal into a light signal or perform a reverse process thereof.

In response to the memory resource request, the network manager may provide the host node with memory node information including one or more of a size of the device memory included in the memory node, a memory start address, and a memory address and connection information including port information of the optical switch.

The frame matcher may collect at least one of device memory identification information, a device memory start address, a memory size requested by the processor, and data to be stored in the device memory by parsing the memory resource request. The frame matcher may acquire a physical address of the device memory on the basis of the memory node information provided by the network manager. The frame matcher may generate the optical link frame including at least one of the device memory identification information, the device memory start address, the memory size requested by the processor, the data to be stored in the device memory, and the physical address of the device memory.

The processing unit and the matching unit may communicate using a PCIe physical layer.

The connection information provided to the host node by the network manager may include information on an optical port of the optical switch connected to the host node, and the network manager may set an optical path to connect the host node and the memory node by controlling the optical switch so that memory resources increase.

The memory node may include the memory unit including the device memory configured to store information, the memory controller configured to control the device memory, and a physical layer configured to convert a received light signal into an electrical signal or perform a reverse process thereof.

The network manager may set information on the memory node and the host node. Here, the memory node may transmit a size of the device memory included in the memory node, address information of the device memory, and information on a physical layer connected to the optical switch to the network manager, and the host node may transmit information on a physical layer connected to the optical switch to the network manager. The network manager may set the information on the memory node and the host node using the information received from the memory node and the host node.

The information on the memory node and the host node may be set in at least one of cases where a new memory node is added, a new host node is added, the memory node starts, and the host node starts.

The light signal may comply with a compute express link (CXL) protocol.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram showing the overview of a device for increasing memory resources according to the present embodiment;

FIG. 2 is a flowchart illustrating the overview of a method of increasing memory resources according to the present embodiment;

FIG. 3 is a block diagram of a host node according to another embodiment;

FIG. 4 is a table showing examples of memory management items managed by a network manager on the basis of information provided by a plurality of memory nodes in a setting operation; and

FIG. 5 is a diagram showing an example of a global memory map generated by the network manager on the basis of the information provided by the plurality of memory nodes in the setting operation.

### DETAILED DESCRIPTION OF EXEMPLARY EMBODIMENTS

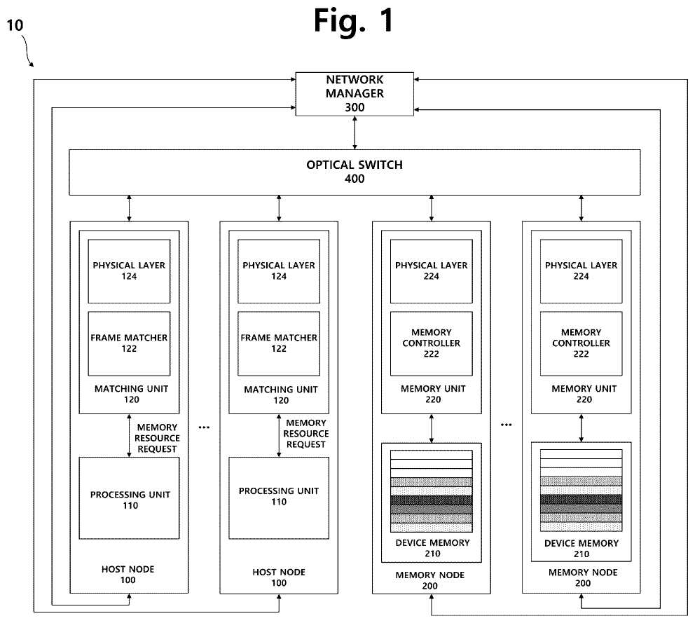

Hereinafter, the present embodiment will be described with reference the accompanying drawings. FIG. 1 is a block diagram showing the overview of a device for increasing memory resources according to the present embodiment. A processing system 10 for increasing memory resources according to the present embodiment includes host nodes 100 which include a processing unit 110 including a processor for generating a memory resource request and a matching unit 120 including a frame matcher 122 for generating an optical link frame from the memory resource request, memory nodes 200 which include a device memory 210 and a memory unit 220 including a memory controller 222 for controlling the device memory 210, an optical switch 400 which optically connects the host nodes 100 and the memory nodes 200, and a network manager 300 which controls the optical switch 400 so that the host nodes 100 are connected to the memory nodes 200 to increase memory resources.

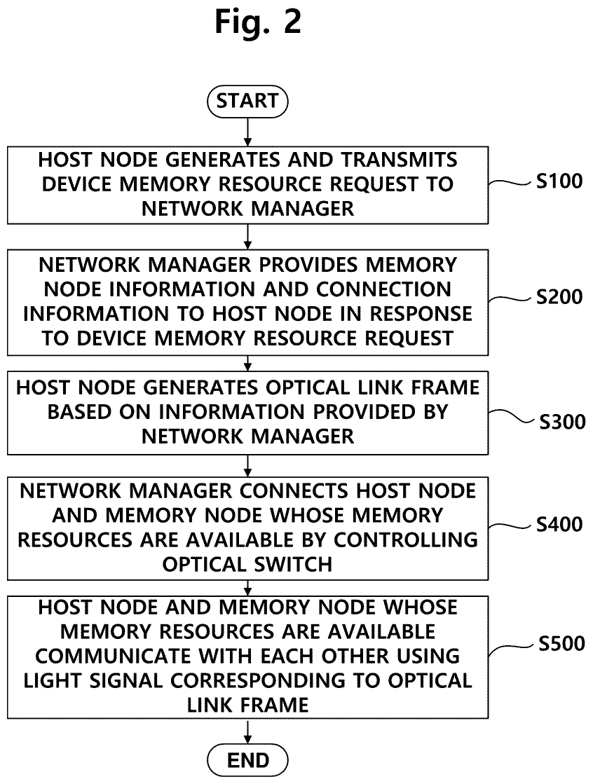

FIG. 2 is a flowchart illustrating the overview of a method of increasing memory resources according to the present embodiment. Referring to FIG. 2, the method of increasing memory resources according to the present embodiment includes an operation S100 in which a host node generates a memory resource request and transmits the memory request to the network manager, an operation S200 in which the network manager provides memory node information and connection information to the host node in response to the memory resource request, an operation S300 in which the host node generates an optical link frame corresponding to the request, an operation S400 in which the network manager connects a memory whose memory resources are available and the host node by controlling the optical switch, and an operation S500 in which the host node and the memory node whose memory resources are available communicate with each other using a light signal corresponding to the optical link frame.

In an embodiment not shown in the drawings, the processing system 10 illustrated in FIG. 1 may start, or a new host node 100 and/or a new memory node 200 may be added to the processing system 10. In this case, a setting operation may be performed before the operation

S100 of transmitting the memory resource request to the network manager. As an example, in the setting operation, the memory node 200 transmits size and address information of a device memory 210 included therein and information on a physical layer 224 connected to the optical switch 400 to the network manager 300. Also, the host node 100 transmits information on a physical layer 124 connected to the optical switch 400 to the network manager 300.

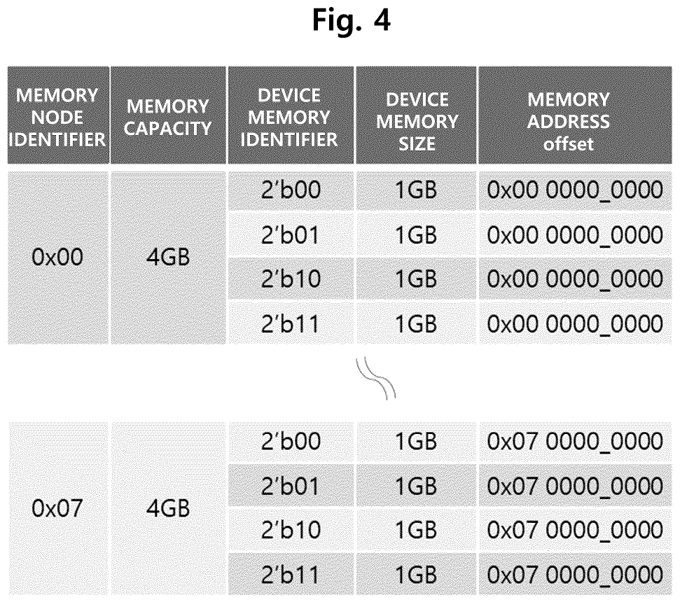

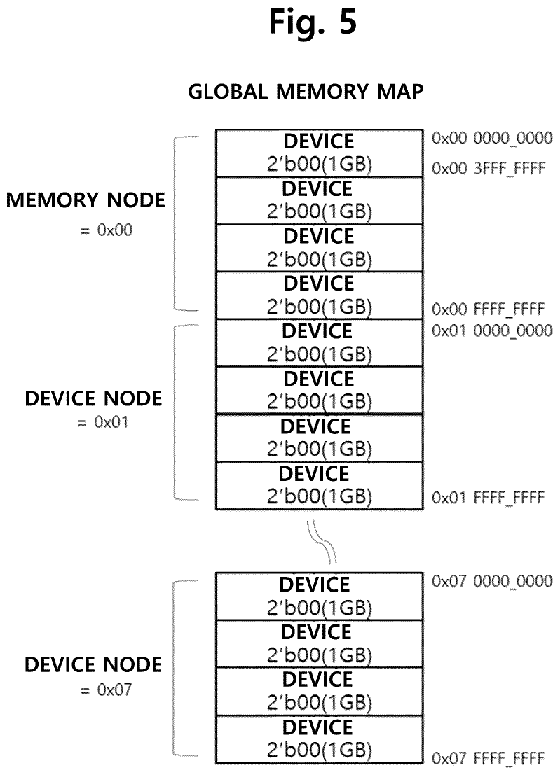

FIG. 4 is a table showing examples of memory management items managed by the network manager on the basis of information provided by a plurality of memory nodes in the setting operation, and FIG. 5 is a diagram showing an example of a global memory map generated by the network manager on the basis of the information provided by the plurality of memory nodes in the setting operation. The management items of FIG. 4 and the memory map of FIG. 5 may be stored in the network manager 300, and required information may be provided upon request from the host node 100.

Referring to FIGS. 1 to 5, each memory node 200 has four 1 GB device memories 210 and thus has a 4 GB capacity. When the device memories 210 have the same capacity as shown in the example, the device memories 210 may have the same start address and the same end address. In this case, as illustrated in FIGS. 4 and 5, a device memory included in a memory node may be identified using a device memory identifier. Even when a plurality of identical memory nodes 200 are connected to the processing system 10, a memory node may be identified using a memory node identifier.

Referring to FIGS. 1 and 2, when the device memory resources in a memory node are required for a process in which a processing unit 110 performs computation, the processing unit 110 transmits a memory resource request to the network manager 300. Communication between the processing unit 110 and the matching unit 120 may be performed using a peripheral component interconnect express (PCIe) physical layer.

As an example, the processing unit 110 may include a single-core or multicore processing device. In an embodiment not shown in the drawings, the host node 100 may include its own host memory. When the capacity of the host memory is not enough, required computation may not be performed by the processing unit 110. In this case, the processing unit 110 generates and outputs a memory resource request. The memory resource request is provided to the network manager 300 (S100).

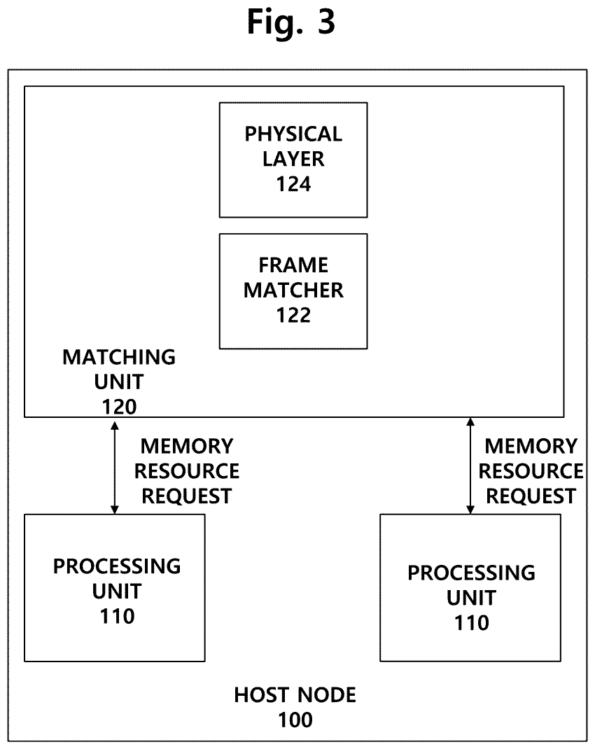

FIG. 3 is a block diagram of a host node according to another embodiment. In the embodiment illustrated in FIG. 3, one or more processing units may be included in a single host node, and each of the processing units may communicate with a matching unit 120 through a PCIe physical layer.

A memory request is provided to the network manager 300. As described above, the network manager 300 provides memory node information and connection information to the frame matcher 122 of the host node 100 in response to the memory resource request (S200). As an embodiment, the memory node information may include one or more of the size of the device memory 210 included in a memory node 200, a memory start address, and a memory address. As an embodiment, the connection information may include port information of the optical switch 400.

The frame matcher 122 may interpret the memory request from the processing unit 110 by parsing the memory request provided by the processing unit 110. As an example, the frame matcher 122 may acquire information on the memory node 200 connected to the optical switch 400, the port information of the optical switch, and a physical address of the device memory 210 from the parsing results.

The matching unit 120 generates an optical link frame from the parsing results and the memory node information and connection information provided by the network manager 300 (S300). As will be described below, the optical link frame may correspond to a light signal transmitted to the memory node 200 through the optical switch 400 or a light signal transmitted to the host node 100 through the optical switch 400. The optical link frame may include identification information of the device memory 210 in which data provided by the processing unit 110 is stored, a start address of the device memory 210 in which the data is stored, a memory size requested by the processing unit 110, the data to be stored in the device memory 210, and the like.

The frame matcher 122 prepares a signal to be provided to the memory node 200 using a port of the optical switch 400 set by the network manager 300. As an example, the frame matcher 122 stores the generated optical link frame in a queue which is connected to the optical port to which the generated optical link frame will be output. The physical layer 124 converts the stored optical link frame into a light signal and outputs the light signal to the optical switch 400. The optical switch 400 is controlled by the network manager 300 to forward the light signal corresponding to the optical link frame to the port connected to the target memory node 200 (S400 and S500).

The physical layer 224 included in the memory node 200 converts the light signal received from the optical switch 400 into an electrical signal and outputs the converted electrical signal to the memory controller 222. Also, the physical layer 224 may convert an electrical signal into a light signal. From the electrical signal corresponding to the optical link frame provided by the physical layer 224, the memory controller 222 separates the identification information of the device memory 210 in which the data is stored, the start address of the device memory 210 in which the data is stored, the memory size requested by the processing unit 110, the data to be stored in the device memory 210, and the like.

The memory controller 222 may identify the device memory 210 in which the data will be stored and an address at which the data will be stored from the identification information of the device memory 210, the start address of the device memory 210 in which the data is stored, and the memory size requested by the processing unit 110 that are included in the optical link frame.

In the illustrated embodiment, the frame matcher 122 generates the optical link frame by coding the provided information and transmits the optical link frame through the physical layer 124 of the host node 100. Also, the optical link frame transmitted through the optical switch 400 is converted into an electrical signal at the physical layer 224 of the memory node 200 and decoded by the memory controller 222.

The frame matcher 122 and the memory controller 222 may perform coding and decoding according to the same protocol. As an embodiment, the frame matcher 122 and the memory controller 222 may perform coding and decoding according to a compute express link (CXL) protocol. Also, the physical layer 124 of the host node 100 and the physical layer 224 of the memory node 200 may transmit and receive a light signal according to the CXL protocol.

According to the present embodiment, as illustrated in FIG. 1, each of the plurality of host nodes 100 can access the device memory 210 of the memory node in the same way that they access a memory included therein. In other words, it is possible to expand memory resources to one or more memory nodes 200.

According to the present embodiment, it is possible to increase the memory resources of a processing system using an optical network.

Although the present invention has been described with reference to exemplary embodiments shown in the drawings to aid in understanding of the present invention, the embodiments are intended for implementation and are merely illustrative. Those of ordinary skill in the art should understand that various modifications and other equivalent embodiments are possible from the embodiments. Therefore, the technical scope of the present invention should be determined from the appended claims.

What is claimed is:

1. A method of increasing memory resources, the method comprising:
generating, by a host node, a device memory resource request and transmitting the device memory resource request to a network manager;
providing, by the network manager, memory node information and connection information to the host node in response to the device memory resource request;
generating, by the host node, an optical link frame corresponding to the device memory resource request on the basis of the information provided by the network manager;
connecting, by the network manager, a memory node whose memory resources are available and the host node by controlling an optical switch; and
communicating, by the host node and the memory node of which memory resources are available, with each other using a light signal corresponding to the optical link frame.

2. The method of claim 1, wherein the host node comprises:
a matching unit including a frame matcher and a physical layer configured to convert an electrical signal into a light signal or perform a reverse process thereof; and
a processing unit including a processor.

3. The method of claim 1, wherein the memory node information includes one or more of a device memory size available in the memory node, a memory start address, and a global memory address, and
the connection information includes information on a port of the optical switch connected to the host node.

4. The method of claim 2, wherein the generating of the optical link frame comprises:
interpreting, by the frame matcher, the memory node information and the connection information to collect at least one of device memory identification information, a device memory start address, a memory size requested by the processor, and data to be stored in the device memory;
acquiring a physical address of the device memory on the basis of the memory node information provided by the network manager;
generating the optical link frame including at least one of the device memory identification information, the device memory start address, the memory size requested by the processor, the data to be stored in the device memory, and the physical address of the device memory; and
interpreting, by the frame matcher, the connection information to determine a port which will output the optical link frame.

5. The method of claim 2, wherein the processing unit and the matching unit communicate using a peripheral component interconnect express (PCIe) physical layer.

6. The method of claim 1, wherein the connection information provided to the host node by the network manager includes information on an optical port of the optical switch connected to the host node, and
the connecting of the memory node and the host node comprises controlling, by the network manager, the optical switch to set an optical path to connect the host node and the memory node by controlling the optical switch.

7. The method of claim 1, wherein the memory node comprises:
a memory configured to store information;
a memory controller configured to control the memory; and
a physical layer configured to convert a received light signal into an electrical signal or perform a reverse process thereof.

8. The method of claim 1, further comprising:
transmitting, by the memory node, a size of a memory included in the memory node, address information, and information on a physical layer connected to the optical switch to the network manager; and
a setting operation in which the host node transmits information on a physical layer connected to the optical switch to the network manager.

9. The method of claim 8, wherein the setting operation is performed in at least one of cases where a new memory node is added, a new host node is added, the memory node starts, and the host node starts.

10. A processing system for increasing memory resources, the processing system comprising:
a host node which comprises a processing unit including a processor configured to generate a device memory resource request and a matching unit including a frame matcher configured to generate an optical link frame from memory node information and connection information input from a network manager;
a memory node which comprises a memory unit including a device memory and a memory controller configured to control the device memory;
an optical switch configured to optically connect the host node and the memory node; and
a network manager configured to control the optical switch so that the host node is connected to the memory node and increases memory resources.

11. The processing system of claim 10, wherein the matching unit further includes a physical layer configured to convert the optical link frame which is an electrical signal into a light signal or perform a reverse process thereof.

12. The processing system of claim 10, wherein, in response to the device memory resource request, the network manager provides the host node with memory node information including one or more of a size of the device memory included in the memory node, a memory start address, and a global memory address and connection information including information on a port of the optical switch connected to the host node.

13. The processing system of claim 10, wherein the frame matcher collects at least one of device memory identification information, a device memory start address, a memory size requested by the processor, and data to be stored in the device memory by parsing the memory resource request,
the frame matcher acquires a physical address of the device memory on the basis of the memory node information provided by the network manager, and
the frame matcher generates the optical link frame including at least one of the device memory identification information, the device memory start address, the memory size requested by the processor, the data to be stored in the device memory, and the physical address of the device memory.

14. The processing system of claim 10, wherein the processing unit and the matching unit communicate using a peripheral component interconnect express (PCIe) physical layer.

15. The processing system of claim 10, wherein the connection information provided to the host node by the network manager includes information on an optical port of the optical switch connected to the host node, and
the network manager sets an optical path to connect the host node and the memory node by controlling the optical switch so that memory resources increase.

16. The processing system of claim 10, wherein the memory node comprises:
the memory unit including the device memory configured to store information;
the memory controller configured to control the device memory; and
a physical layer configured to convert a received light signal into an electrical signal or perform a reverse process thereof.

17. The processing system of claim 10, wherein the network manager sets information on the memory node and the host node,
wherein the memory node transmits size of the device memory included in the memory node, address information, and information on a physical layer connected to the optical switch to the network manager, and
the host node transmits information on a physical layer connected to the optical switch to the network manager, and the network manager sets the information on the memory node and the host node.

18. The processing system of claim 17. wherein the information on the memory node and the host node is set in at least one of cases where a new memory node is added, a new host node is added, the memory node starts, and the host node starts.
